(19) United States
(12) Patent Application Publication
(10) Pub. No.: US 2012/0022685 A1
(43) Pub. Date: Jan. 26, 2012

(54) Method for operating an electric charging station

(75) Inventors: Norbert Miller, Monchengladbach (DE); Josef Baum, Monchengladbach (DE); Ulrich Fleps, Wassenberg (DE)

(73) Assignee: SCHEIDT & BACHMANN GMBH, Monchengladbach (DE)

(21) Appl. No.: 13/187,542

(22) Filed: Jul. 21, 2011

(30) Foreign Application Priority Data
Jul. 21, 2010 (EP) 10 007 550.6

(51) Int. Cl. G06F 17/00

(52) U.S. Cl. 700/232

(57) ABSTRACT

A method for operating an electric charging station within a parking area proposes operating an electric charging station within a parking area, wherein an identification device is used by a user when entering into the parking area, wherein the identification device provides a unique identification, wherein a current supply device of the charging station is activated by the user by using the identification device whereupon the current supply device is available for a charging process.

### BACKGROUND OF THE INVENTION

The invention is related to a method of operating an electric charging station in a parking area.

Electric charging stations are known from the state of the art. They comprise current supply devices, which most simply are formed as electrical sockets.

For the purpose to charge a battery, for example an accumulator of an electric car, the battery can be connected to the current supply device. This can typically be effected by a charging cable carried along by the electric vehicle. This charging cable is on the side of the current supply device equipped with a plug which is compatible to an electrical socket provided by the current supply device. As soon as the plug of the charging cable is connected to the electrical socket of the current supply device, the charging process can start.

After completion of a charging process an accounting is effected due to the amount of current taken from the current supply device.

Furthermore parking areas are known from the state of the art. These include in particular parking garages, car parks and other parking lots. In pay parking lots the accounting of the parking fee is effected when the parking is ended, wherein common parking areas typically comprise barriers which allows leaving the parking area only after paying the parking fee. In this context in particular automatic payment systems are used, which are based on paying stations, magnetic stripe cards and ChipCoins and/or the like.

The invention is related to a method of operating an electric charging station, namely such an electric charging station in a parking area. The object of the invention is to propose a method which is carried out more simply.

### SUMMARY OF THE INVENTION

As a solution the invention proposes a method for operating an electric charging station within a parking area, wherein an identification means is used by an user when entering into the parking area, said identification means providing an unique identification, wherein a current supply device of said charging station is activated by the user by using the identification means and thereupon the current supply device being available for a charging process.

According to the method according to the invention it is intended that an identification means is used by a user when entering into the parking area. Said identification means may be a magnetic stripe card, a ChipCoin, a bar code card or the like. The identification means can be distributed to the user when entering into the parking area. This is typically the case in single parkings. According to an alternative embodiment the identification means can be carried along by the user and being presented, read and/or recorded when entering into the parking area. Typically this alternative embodiment is used by so called long-term parkers.

The method according to the invention requires that the identification means provides an unique identification. For instance, the unique identification can be an identification number, combined with other information like for example the instant of time when entering the parking area and/or the like. If the user wants to use the electric charging station installed within the parking area, it is possible by using the identification means carried along by the user. According to the method it is intended that a current supply device of the electric charging station can be activated by the user by using the identification means. For this purpose it can be intended that the current supply device comprises a card reader and/or ChipCoin reader device, that is to say a reading device to read out the unique identification provided by the identification means. When the current supply device is activated the current supply device is available for a charging process. Now, a battery, in particular a battery of an electric car can be connected to the current supply device for the purpose of charging. The identification means is also used to complete the charging process. With the unique identification, the user can end the charging process by using the identification means.

The accounting of the amounted parking fee on the one hand and of the incurred current fee on the other hand is effected in common for example by using the identification means for single parkers or within a monthly accounting for long-term parkers.

The method according to the invention allows charging of the electric vehicles where they are parked, namely in parking garages and car parks for example in shopping malls or the like. The method according to the invention proposes to connect the charging infrastructure, the authorisation of the electric charging station and the payment with standardized interfaces of parking systems. The user pays as usual his parking ticket or his ChipCoin including the overall current fee that is encoded within the parking ticket or the ChipCoin. The accounting of single parkers can be effected at pay machines in an usual manner. The accounting of long-term parkers can be effected in a monthly billing also in an usual manner. Advantageously an operator will not have to invest additionally in an authorization and accounting system for the charging infrastructure and user, e.g. customers, can use an existing system as usual and will not have to get accustomed to an additional system. The method according to the invention turns out to be extremely simple in terms of usage as well as in terms of implementation.

The identification means according to the method according to the invention serves the user as an authorization and accounting system for the electric charging station which is provided in the parking area. If the usage of the electric charging station has not taken place, that means if the current supply device is not used by an user, the identification means serve in a common way for the accounting of the parking fee. If the user is using the electric charging station installed in the parking area, this can be accounted without an additional authorization and/or accounting system, because according to the invention the user is using an existing identification means to park in any case.

In case of receiving current from the electric charging station the incurred current fee and the incurred parking fee will be accounted in common. The cash register system which is provided for the accounting of the parking fee anyways can be used in an advantageous manner, if the implementation of an additional system for accounting the incurred current is not necessary. The accounting of the current fee can be carried out in different ways. The incurred current fees can be positive, zero or negative.

According to a first alternative embodiment of the method according to the invention, the charging process is ended by paying the amounted current fee. According to this alternative embodiment a payment is carried out for example at a paying machine. The accounting process is initiated by the identification means. The total amount of fees to pay is displayed to the user at the paying machine. Simultaneously to the paying at the paying machine the receiving of current is finalized, which means that the charging process stops. The total amount to pay is composed of the parking fee and the potential current fees. Thereupon the user can disconnect the charged battery of his electric vehicle from the electric charging station and exit the parking area. This alternative of the method according to the invention requires an online-service between the electric charging station and the paying machine.

According to a second alternative of the method according to the invention it is intended, that the charging process is ended chronologically after a payment, wherein a payment of the incurred fees which is linked to the identification means will be evaluated by the current supply device. According to this alternative initially a payment of incurred fees is done at the paying machine. The incurred fees are calculated by means of the data saved on the identification means carried along by the user. As soon as the payment is effected it is recorded on the identification means. Thereupon the user proceeds to the current supply device he has utilized where the identification means is read out. Once the payment is recorded by the electric charging station, the charging process will stop. Preferably in this context it is intended, that the user has a certain time slot for disposition between the payment on one side and the initiation of the ending of the charging process on the other side. This alternative embodiment of the method can be effected in online-service as well as in offline-service.

According to a third alternative of the method according to the invention it is intended that the charging process is ended before a payment of the fees connected to the identification means is carried out. This alternative embodiment of the method is especially advantageous for offline-service between electric charging station and paying machine. Thereupon the user proceeds first to the current supply device he is using and stops the charging process by reading in the identification means. The data of the current delivery is saved in the identification means. Thereupon the user proceeds to the paying machine. His identification means contains all information for calculation of the current fee as well as for the parking fee. After the payment is done at the paying machine, the user gets his identifications means back, which now carries the additional information, that all fees are paid. Then, the user has to exit the parking area within a presettable time period.

According to a fourth alternative of the invention the charging process is ended by reading in the identification means and a usage is recorded on the identification means or in a parking garage management system. This alternative embodiment of the method is especially suitable for long-term parkers. After ending the charging process the long-term parker can directly proceed to the exit without making a detour to the pay station. The amounted fees are recorded and accounted periodically.

To particularly take care that the payment is actually effected in case of a current delivery from the electric charging station, according to a further feature of the invention it is intended out of safety reasons that with the start of the charging process and after reading in the unique identification provided by the identification means the charging plug is locked on part of the current supply device and this locking is released not until the identification means are reread. Preferably this locking is carried out mechanically. For example a fastener clip can be provided which is pivoted at the beginning of charging process and which locks the charging plug which is connected to the electric socket of the current supply device in such a manner that a non-destructive unplugging of the same out of the current supply device is not possible. Hereby, it can be ensured that the charging plug can only be unplugged by an authorised person, which possesses the identification means.

According to a further proposal of the invention the charging process can be started again if the charging plug is not unplugged during a presettable time slot after ending the charging process.

According to a further feature of the invention it is intended that when entering into the parking area free parking spaces comprising a current supply device are indicated to the user. This feature facilitates the finding of current supply devices in the parking area for the user. In this context it can further be intended that electric vehicles are automatically identified when entering the parking area and an indication of free parking spaces comprising a current supply device is only carried out in these cases and/or on a user's request.

The total power provided by the current supply devices of the electric charging station is centrally recorded. Possible overload of the system can be detected and when necessary, required countermeasures can be initiated in good time.

According to a further feature of the invention the total amount of available energy is allocated based on utilization profiles and/or time profiles. According to this specific implementation of the method the current delivery is carried out with respect to presettable parameters. For example a time profile can be taken into account during the charging process, depending on whether a short-term parking or long-term parking is intended. In case of long-term parking cheaper off-peak electricity can be used. Further the charging time can be scheduled to such a time of the day, so that possible electricity peaks are avoided. Further an utilisation profile can be considered while charging, which means that for example the charging is carried out during the typical working times or during the week-end. Further it can be considered whether the vehicle connected to the current supply device is mainly used in the city traffic or on long-distances. Preferably utilization profiles and/or time profiles can be recorded and are saved. This can for example be carried out already during the reservation of a parking space.

In this context is it can be intended that vehicles where a current utilisation profile is known, are automatically directed to a parking space which comprises a current supply device. In particular this alternative of the method is advantageous in the case of long-term parkers because already while entering the parking area the system detects whether a charging process is due or not.

According to a further feature of the invention in particular for security reasons further identification media besides the already existing identification means can be provided, such as data storages, by means of which an identification of the user is carried out. This can be in particular such data storages that are already possessed by the user, for example credit cards, identification cards, passports and/or the like.

The rate calculation, that is to say the calculation of the current fee, can be effected in dependency of the kind of current, wherein it can preferably be distinguished between alternating current (AC) and three phase electric power.

According to a further feature of the invention the user can have a selection of different charging priorities for choice. According to a first charging priority it can be intended that the charging process is effected during such a time slot where the current delivery is comparably cheap. According to another priority it can be intended that the charging process starts in any case, even though comparably expensive current has to be used.

According to a further feature of the invention a charge and/or a load management is used. This serves in particular to accomplish the charging process optimal in the available time. It can be provided, that the energy of an accumulator of an electric vehicle is used to charge other vehicles, before this accumulator is completely recharged again. In this manner an optimized charging can be achieved system-wide, whereas electricity peaks are mostly avoided, a gentle charging of accumulators is provided and finally preferably as cheap as possible current is used for charging.

According to a further feature of the invention it can be intended that a central capture in regard of the used current supply devices is effected. This can be displayed to the user as well as the prognosticated waiting time in case that all current supply devices are occupied.

### BRIEF DESCRIPTION OF THE DRAWINGS

Further features and advantages of the invention can be derived from the following description by means of the figures. The figures show:

FIG. 1 a diagrammatic view of a parking area which comprises an electric charging station;

FIG. 2 a diagrammatic view of a current supply device of an electric charging station; and

FIG. 3 a diagrammatic view of a possible sequence according to the inventive method.

### DESCRIPTION OF PREFERRED EMBODIMENTS

FIG. 1 shows in a diagrammatic view a parking area 1 in the form of a parking space. This parking space comprises in a well-known manner an entrance 4 and an exit 5 which preferably both are equipped with barriers.

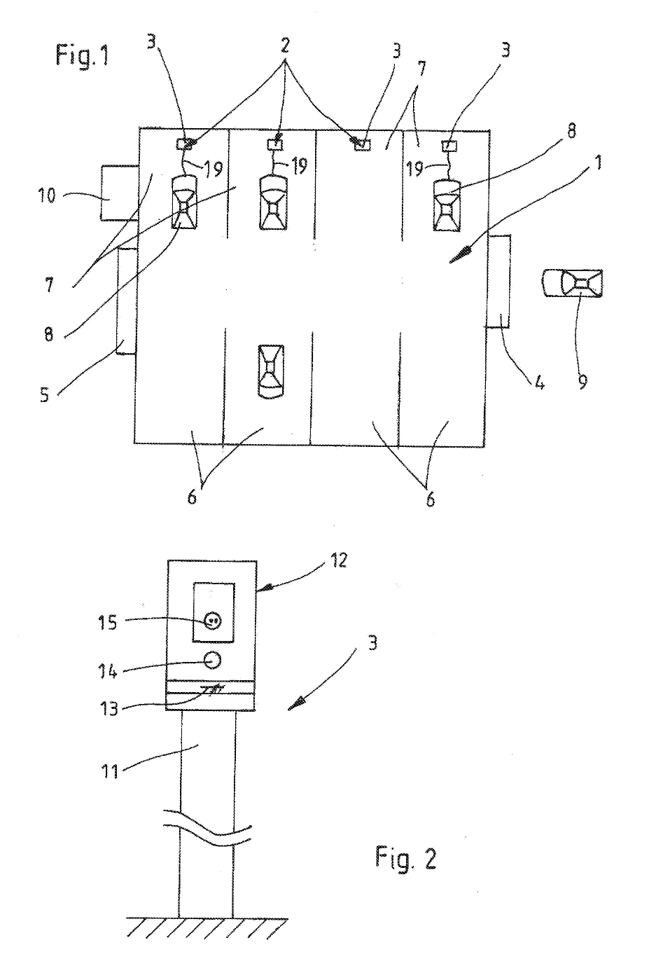

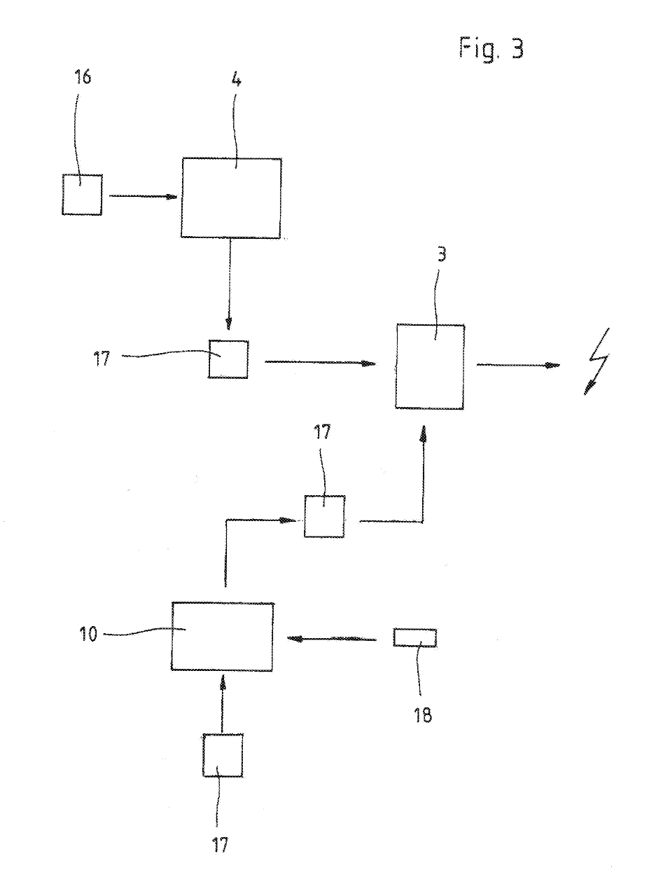

The parking area 1 comprises an electric charging station 2, which provides a plurality of current supply devices 3. A current supply device 3 can for example have the form of a dispenser, in particular as a current dispenser, as depicted diagrammatically in FIG. 2.

The parking area 1 according to FIG. 1 provides a plurality of parking spaces 6 and 7, in particular for cars 8 and 9. According to the shown embodiment according to FIG. 1 each parking space 7 is equipped with a current supply device 3. The parking spaces 6 respectively are not equipped with a current supply device 3.

According to FIG. 1 each car 8 arranged in the parking spaces 7 is connected in a conducting manner via a charging cable 19 to the respective current supply device 3. With the current supply device 3 a charging of the accumulator carried by the respective cars 8 can be effected.

Preferably, an automated identification of a car 9 entering into the parking area 1 is carried out depending on whether the car 9 is an electrical car or a conventional car. As an electrical car is identified by the system or the user is requesting such an identification, on the part of the system an advice or rather information about free parking spaces which comprise a current supply device 3 is provided. In this embodiment still one parking space 7 which comprises a current supply device 3 is available. Preferably, the user is guided to this available parking space 7 by a management system of the parking area 1.

At the time of entrance into the parking area 1 the user is provided with an identification means. This identification means can be a parking card, a ChipCoin or the like. This identification means is used in a known manner for the accounting of parking fees, for which purpose a paying machine 10 known from the state of the art is used.

As soon as the car 9 is parked in the intended parking space 7, the car 9 is connected to the respective current supply device 3 via a charging cable 19. In this manner a conducting connection between the car 9 on the one hand and the current supply device 3 on the other hand is established. Then, to start the charging process the current supply device has to be activated. This is carried out by the user by means of the identification means that has been provided at the time of entrance into the parking area 1. As soon as the current supply device is released, the charging process can start. Preferably, the user can preset charging parameters, for which purpose the current supply device 3 comprises a respective input device.

As the charging process starts, the plug of the charging cable 19 which is connected to the electric socket 15 of the current supply device 3 is preferably mechanically locked against an unplugging. At least a non-destructive unplugging is prevented. An unplugging of the charging plug is not allowed until the user pays the incurred parking fees and current fees at the paying machine 10 and the users identification means which contains the respective paying data is read by a reading device of the current supply device 3.

The current delivery by the current supply device preferably ends as the parking fees and current fees are paid at the paying machine 10. Preferably, if the current supply device 3 is in an offline-service it is intended that the current delivery ends as soon as the paying data which is recorded on the identification means is read by the current supply device and on part of the current supply device the duly paying is detected. In the case of long-term parkers a periodically accounting can be effected, for example a monthly accounting.

FIG. 2 shows in a diagrammatic view a current supply device 3 in form of a current dispenser. This current dispenser comprises a dispenser body 11 on which an interface device 12 is arranged. The interface device 12 provides an electric socket 15 for receiving the plug of a charging cable 19. Further, a slot 13 for receiving an identification means in form of a magnet card as well as a transmitting and receiving device 14 for utilization with identification means in form of ChipCoins are provided. The interface device 12 can further comprise a display for further input of information by a user, which display is not shown in the figure. For example utilization profiles and/or time profiles can be preset such that the charging is carried out only at certain times or only for a certain time period independent from the parking period.

FIG. 3 shows in a diagrammatic view a possible sequence of the method. A user 16 enters into the parking area 1 and receives as he enters into the parking area 1 an identification means 17 in form of for example a known parking card. As soon as the user 16 has parked his vehicle and has connected this vehicle to a current supply device 3, an activation of the current supply device 3 is carried out by means of the identification means 17, whereupon the charging process starts.

As the user returns into the parking area 1, the user 16 inserts the identification means 17 into the paying machine 10. The paying machine 10 calculates the parking fees and the current fees, wherein the calculation of the current fees is based on the amount of taken current. Most simply, for the determination of the amount of current taken a current measuring apparatus is used.

The user 16 balances the fee accounted by the paying machine 10 by means of a paying means 18, for instance a credit card. The paying machine 10 writes paying data to the identification means 17 and the identification means 17 is released to the user 16. Then, the identification means 17, which is provided with paying data, can be inserted into the current supply device 3 by the user for the purpose of readout. As soon as the current supply device has analyzed the paying data from the identification means 17 and has detected the duly paying of the incurred parking fee and current fees, an activation of the mechanically locked plug 19 is effected, such that the user 16 then can disconnect his vehicle from the current supply device 3 and leave the parking area 1.

### LIST OF REFERENCE SIGNS

1 parking area
2 electric charging station
3 current supply device
4 entrance
5 exit
6 parking space
7 parking space
8 car
9 car
10 paying machine
11 dispenser body
12 interface device
13 slot
14 receiver/transmitter
15 electric socket
16 user
17 identification means
18 paying means
19 charging cable

What is claimed is:

1. A method for operating an electric charging station (2) within a parking area (1), wherein an identification means (17) is used by a user (16) when entering into the parking area (1), said identification means (17) providing a unique identification, the method comprising the steps of activating a current supply device (3) of said charging station (2) by the user (16) by using said identification means (17) whereupon said current supply device (3) is available for a charging process.

2. The method according to claim 1, comprising completing said charging process by paying incurred fees.

3. The method according to claim 1, comprising completing said charging process chronologically after paying, wherein paying of incurred fees, linked to said identification means, is evaluated in said current supply device (3).

4. The method according to claim 1, comprising completing said charging process prior to paying incurred fees, linked to said identification means.

5. The method according to claim 1, comprising completing said charging process by the user by using said identification means.

6. The method according to claim 1, comprising effecting common accounting of incurred parking and charging fees.

7. The method according to claim 1, comprising locking a charging plug by said current supply device when beginning said charging process and/or after read-out of said unique identification provided by said identification means and releasing locking of said charging plug by another reading of said identification means.

8. The method according to claim 1, comprising indicating to the user, when entering into said parking area (1), free parking spaces (6, 7) comprising a current supply device.

9. The method according to claim 1, comprising automatically identifying electric vehicles when entering said parking area (1).

10. The method according to claim 1, comprising collecting centrally a total power provided by said current supply devices of said electric charging station.

11. The method according to claim 1, comprising allocating a total amount of available energy to said current supply device (3) of said electric charging station (2) based on utilization profiles and/or time profiles.

12. The method according to claim 1, comprising employing a charge and/or a load management.
